(19) United States
(12) Patent Application Publication
(10) Pub. No.: US 2012/0102537 A1
(43) Pub. Date: Apr. 26, 2012

(54) Method and Apparatus for Interaction Between Parties in a Commercial Transaction

(76) Inventor: Samuel Der-Kazaryan, Atlanta, GA (US)

(21) Appl. No.: 12/941,986

(22) Filed: Nov. 8, 2010

Related U.S. Application Data
(60) Provisional application No. 61/406,869, filed on Oct. 26, 2010.

(51) Int. Cl. G06Q 30/00; H04N 7/173; G06Q 90/00

(52) U.S. Cl. 725/131; 705/500; 705/26.3

(57) ABSTRACT

A method and apparatus for auctioning the time of an individual. The method includes the steps of receiving from an individual a desired set of characteristics. The desired set of characteristics includes at least an indication of one or more periods of time during which the individual is available to receive content, a minimum charge for receiving the content, and a method by which the individual wishes to receive the content. The desired set of characteristics indicated by the individual is presented in the form of an auction. A bid is received from one or more bidder to present content to the individual in accordance with the desired set of characteristics. An agreement n received from the individual to receive the presented content at the bid price.

### CROSS REFERENCE TO RELATED APPLICATIONS

This application claims the benefit of U.S. Provisional Patent Application No. 61/406,869, filed Oct. 26, 2010, titled “Method and Apparatus for Interaction Between Parties in a Commercial Transaction, currently pending, the contents thereof being incorporated herein by reference.

### FIELD OF THE INVENTION

This invention relates generally to presentation of a new economic model distributing the control and benefits of a relationship between consumers, brand marketing groups, and potentially any third party beneficiary, and more particularly to auction of a consumer participant's time, thus using the participant's time as a commodity, to provide a benefit to the participant, the brand marketing groups, and one or more beneficiary parties receiving a portion of the benefit provided to the participant for auctioning their time.

### BACKGROUND OF THE INVENTION

The relationship between consumers and brand marketers has always had the potential to be somewhat adversarial. Brand marketers try to get consumers to look at advertising or other brand related material, while consumers attempt to avoid any such advertising. Such a relationship exists across many different types of media.

Today's online marketing and advertising industry model is dominated by content publishers, large portals and social networks, and many sites that sell advertising spots embedded in their digital content. This advertising paradigm has been carried through various media types, from print and radio to TV and Internet. Since the early days of Internet adoption, various digital media such as video, audio, interactive flash applications, search marketing and others, have evolved to support this model of translating the old-school advertising models to new media platforms. In one form or another, advertising is displayed to a user based in part upon sites they are viewing, search terms they are typing, shows they are watching, other method of indicating interest in a particular topic, or one or more other user-related attributes.

Rather than displaying paid for advertising on a neutral site, individual corporate websites, dedicated brand web sites and intranets display captive advertising for a particular company, brand or the like. While often attempting to appear to be providing unbiased information to prospective users, these captive websites have too many times become marketing and advertising platforms for presenting relevant advertisements to participating suppliers, clients, partners, and employees. Once again, such sites wait for individuals to access the sites, and therefore to be exposed to the advertising information, while these individuals likely attempt to avoid any marketing scheme presented to them.

Even with these drawbacks, online marketing and advertising is, of course, quite effective and popular. Social networks offer embedded content and external application APIs to allow for easy launching of marketing campaigns. Search engine giants such as Google® offer comprehensive marketing networks with comprehensive platforms and tools to make the process even for the smallest of website owners an easy and productive one. Many news networks, social and professional sites, online communities and the like have jumped onto the “sell your traffic” paradigm, turning their hard-earned traffic on the Internet into profits. Good content and web traffic has become a commodity traded on a CPC (Cost per Click) or CPA (Cost per Acquisition) basis. Unique targeting technologies have been developed to better target consumers and provide them with more relevant advertising and interactions, including some of the techniques mentioned above.

And of course, the rise of Google® and Facebook® have been amazing success stories of the past decade, much of it attributed to advertising revenues. As of July 2008, over 1 trillion pages had been indexed on the Google® search index and the number likely has multiplied since then. Despite the various properties that the company owns, nearly 97% of all its revenues come from online advertising.

In a recent study conducted to figure out why business professionals use social media, close to 86% of the respondents had been found to be using social media for their business. Of them, a majority use the service for marketing purposes. Below is a breakout by percentage of the different ways business professionals use social media:

Marketing: 57%

Internal collaboration and learning: 39%

Customer Service/Support: 29%

Sales: 25%

Human Resources: 21%

Strategy: 16%

Product Development: 14%

Other: 31%

And, according to a study of social media participation by small businesses in North America conducted by eMarketer Association, more than 260,000 small and medium businesses in North America have been engaging in social media activities in order to grow their business. The most popular social media activities were determined to be:

Professional Social Networking: 51%

General Social Networking: 44%

Niche/Industry specific communities: 38%

Job sites: 37%

Blogging/Microblogging: 28%

Forums and product focused sites: 28%

Wikis: 24%

Social bookmarking: 6%

Current market participants in this industry fall into two main categories, providers that serve advertisements to sites, and site owners that allow for advertising on their sites. Advertising networks and technology platforms (such as Google® or ClickPath®) provide contextually linked ads within site content. Site owners agree to allow these participants to push advertising onto their sites, while brands pay these participants to have their advertising pushed to websites likely to be of interest to their potential customers, or for some other form of contextual linking so that their advertising is (hopefully) displayed to a most relevant population. These market participants use advertising models that employ push advertising where ads are delivered to Internet users without their consent.

Large portal sites, and advertising agents or other intermediary media houses, sell advertising space online. Large portal providers are the ultimate owners of content being displayed on their sites, and thus can dictate advertising media and pricing terms to others interested in placing advertisements on their site. Both advertising networks and portals target advertising brands as their target consumer base. The value delivered through their services is proportional to the amount of traffic drawn to the portal or site, although often times in a subjective manner. These businesses have a closer relationship to consumers, since the consumers willingly choose to come and spend time on their site. However, the consumers still do not have a say in what marketing communications are delivered to them, how, and when. The control of the channel is in the hands of the portals, as well as the control of price for brands.

A number of existing systems attempt to provide an auction system allowing a consumer or the like to participate. U.S. Pat. No. 7,698,165 describes a facility for performing on-line advertising at a subject web site relative to a selected user activity. The facility receives a plurality of bids. Each bid is submitted on behalf of an advertiser, and specifies an advertising rate that the advertiser will pay in cost per impression to display an advertising messages to users performing the selected activity with respect to the subject web site. When a request for any web page of the subject web site containing advertising space is received from a user that has previously performed the selected activity, irrespective of the identity of the requested web page, the facility both (1) identifies the received bid specifying the largest advertising rate, and (2) causes an advertising message to be displayed in the advertising space of the requested web page for the advertiser on whose behalf the identified bid was submitted. While employing an auction system, this patent does not include the ultimate consumer of the advertising, and further does not allow for brands to be sure that their marketing dollars are allowing them to reach willing consumers.

US Patent Application Publication No. 2005/0283420 facilitates a calendar auction over a computerized network wherein consumers of professional services may bid on calendar timeslots for needed professional services. A provider creates an account and manages an online calendar to facilitate actions for defined timeslots. A consumer also creates an account and manages an online calendar to solicit calendar auctions for specific needed professional services over defined times-lots. Both provider and consumer manage their calendar auction accounts and calendar over a computerized network such as the Internet. This system, however, is not directed to consumers, beneficiaries or the like, but rather providers of goods and services. Therefore, there is no benefit of this system to allowing brands to be sure their marketing dollars allow them to present material to willing consumers

US Patent Application Publication No. 2008/0005017 describes a method for identifying charitable organizations to receive the proceeds generated from the sale of merchandise includes communicating information to purchasers of the merchandise including a price, identities of charities to which donations can be allocated, and a donation amount. An offer to purchase the merchandise and the identities of two or more charities to which the donation is to be allocated is received. While involving charitable organizations, there is no description of the use of an auction system, and indeed, a purchase is necessary before any funds are transferred to a charitable organization.

US Patent Application Publication No. 2004/0260645 describes a system for identifying customers and their purchases with organizations with a cause designated to receive a part of the customer's purchase amount as a credit. The method uses the system to identify customers with their respective organizations with a cause and then records all transactions between the customer and the respective organization with a cause and allocates credits to the system, the organization with a cause, other participants such as account managers and computes the credits with respect to separate algorithms for each of the marketing distribution levels associated with a transaction. While the publication describes a system in which funds are in part allocated to an organization, the transfer is based upon actually spent funds, and not associated with the allocation of a consumer's time.

Facebook® Causes may allow users to engage in marketing activity to earn money for a charity. The user that visits a Charity page on the Facebook® Causes page is offered to participate in an activity, such as a survey for a brand, and earn funds for the charity. The system, however, does not allow the user to designate a level of support or contribution, does not allow the user to also monetize their time, and offer their time through an auction system, and does not allow the user to choose or otherwise designate a type of media or delivery system by which the user would prefer to receive the information from the brand or other marketing organization.

Crowdtap is a web platform that provides online, web based marketing studies to participants and sponsored by brand marketing organizations. Participants that participate in one or more marketing surveys designate a 5% portion of any proceeds they may be paid to one of three selected charities. While innovative, the Crowtap system does not allow the participant to select from a wide variety of beneficiaries, requires participants to interface through the Crowdtap website, does not give the participants control on what information they provide, and how that information will be used, and ultimately does not provide a method or system for allowing or auctioning of a consumer's time in a manner that gives the consumer some control over time and method of delivery, and subject matter of content.

US Patent Application Publication No. 2008/0167943 teaches an advertising tool for auctioning of advertising time by content providers and advertizing networks. Viewership data related to a viewer's selection and use of media content is utilized to match the viewership data with advertising data to identify one or more advertisements that may be desirable for distribution during a particular advertising time slot. A bid price is then established for each of the advertising time slots. While employing an auction system to set the price of advertising time, this system fails to allow the consumers to have any control over their time, the auction system, or requested method of content delivery.

US Patent Application Publication No. 2009/0150237 describes a point based auction wherein providers of products and/or services may bid on an opportunity to sell to a group of consumers who have indicated desire to purchase goods and/or services. Such a computerized reverse auction fails to teach the auctioning of consumer time for receiving content, and is rather only focused on transactions involving purchase of goods and services.

US Patent Application Publication No. 2008/0262917 describes a broker system for allowing advertisers to place advertisements on websites by bidding for the space on the website. Thus, while an auction system is employed, including a broker in the transaction, there is no teaching of consumer control over content, and no description of a consumer time auction.

U.S. Pat. No. 6,324,519 presents an advertisement auction system where the advertiser is able to bid on the right to present an advertisement top a particular consumer. The consumer information is provided by a website or the like including an advertising opportunity. Upon evaluating the opportunity, a bid may be placed. This system, however, does not include the consumer in the auction process, and therefore merely presents a better method for advertisers to present advertisements to consumers. No control over the content delivery is given to the consumer.

Therefore, few if any of these existing solutions, however, may allow for the explicit control over interactive engagements by a consumer so that the consumer receives these communications/interactive engagements of interest to them, and brands are able to provide appropriate advertising to those who may be interested.

Further, none of these advertising models additionally may provide an immediate benefit to the consumers of media at time of transaction, with the exception of some discount based offers.

Further, none of these advertising models additionally may provide a direct connection between this consumer and a beneficiary organization in a complete and consumer-controllable manner.

Therefore, it would be desirable to provide an apparatus that overcomes the drawbacks of the prior art.

### SUMMARY OF THE INVENTION

In accordance with the present invention, a global time marketplace auction service is preferably provided where consumers may use their time as a commodity, and may auction part of their time through a non-intrusive, automated online or otherwise accessible exchange. Such exchange may be accessible to consumers via various mobile devices, Internet, set top box, other hardware or other communication systems. This time may be auctioned off to brands through a self-pricing auction so that the users agree to receive particular targeted advertising for a fee established through a brand bidding process, while brands are assured a relevant audience and return on advertising spend (ROAS) based on metrics defined by the brand. Thus, a brand may be able to define one or more metrics that are to be met by a particular advertising campaign. Meeting of these metrics, and proper measurement of these metrics may be provided so that the brand may be sure of valuable results, or may wish to change the advertising campaign if such metrics are not being met. Such an auction, therefore, benefits consumers by allowing them to indicate a time and method of relevant information delivery, while also benefiting buyers of consumer time, including brands, marketing/PR, and other organizations that are interested in establishing a direct consumer channel that supports various modern digital communication channels, media and online marketing campaigns.

Another embodiment of the present invention may also preferably fulfill a social role in building a better world by enabling social funding of beneficiary projects through direction of a certain portion of the auction fee paid to a user to one or more of these beneficiary groups that may comprise charitable organizations, or other designated projects, such as possibly governmental or quasi governmental projects, privately run projects, other social projects or the like. The beneficiaries of such funding may be any corporate or private entities that have clearly defined projects that need funding, and preferably make a commitment to well defined milestones and agree to report on project status and progress. It is intended that such an inventive time auction may integrate with online social networks and other related online services such as Facebook® Causes, charity fund raising sites, affiliate marketing networks, and digital media platforms.

The present invention therefore preferably provides a platform, system and process that presents a new paradigm for the interaction between consumer, brands and beneficiaries. The invention further preferably gives brand organizations an open and direct partnership with consumers, allows consumers to have some say in the type of interaction they will have with brands and brand organizations, and allows these brands and brand organizations to target relevant consumer populations. The invention additionally preferably may also allow the consumer, and in turn the brand organizations, to support social funding for beneficiary projects that the consumer designates to receive part of any monetary payment the consumer receives in exchange for their auctioned time. Consumer-friendly marketing solutions may be provided to brand organizations that focus on fair value distribution to consumers. These brand organizations, in turn, are preferably able to take advantage of a direct marketing channel to these willing, potentially desirable, consumers.

It is therefore an object of the present invention to overcome the drawbacks of the prior art.

Still other objects and advantages of the invention will in part be obvious and will in part be apparent from the specification and drawings.

The invention accordingly comprises the several steps and the relation of one or more of such steps with respect to each of the others, and the apparatus embodying features of construction, combinations of elements and arrangement of parts that are adapted to affect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a flowchart diagram depicting an overall relationship between brand organizations, consumers, beneficiaries and the auction marketplace of an embodiment of the present invention;

FIGS. 2a-2d are flowchart diagrams depicting an overall view of a consumer interaction with an auction marketplace in accordance with an embodiment of the invention;

FIG. 3 is a screen shot depicting a consumer initiating contact with the auction marketplace in accordance with an embodiment of the invention;

FIG. 4 is a screen shot depicting a summary display of a consumer account in accordance with an embodiment of the invention;

FIG. 5 is a block diagram depicting account settings for a consumer account in accordance with an embodiment of the invention;

FIG. 6 is a screen shot depicting selection of a beneficiary project in accordance with an embodiment of the invention;

FIG. 7 is a flowchart diagram depicting an overall system interaction of the consumer in accordance with an embodiment of the invention;

FIG. 8 is a block diagram depicting an overall view of a beneficiary interaction with an auction marketplace in accordance with an embodiment of the invention; and

FIG. 9 is a block diagram depicting an overall view of a brand organization interaction with an auction marketplace in accordance with an embodiment of the invention.

### DETAILED DESCRIPTION OF THE PREFERRED EMBODIMENTS

The invention will now be described making reference to the following drawings in which like reference numbers denote like structure or steps.

In accordance with an embodiment of the invention, an inventive consumer and brand interaction paradigm, preferably including a time auction first and foremost allows a consumer to directly participate in the value and monetary chain of advertising dollars spent by brand organizations, and allows brand organizations to reach desirable consumers with desired characteristics, interests and/or preferences in a cost effective manner, and at a time when they may be most receptive to receiving such advertising. Rather than simply placing advertisements online and hoping one or more individuals interested in the advertised good or service actually see and engage with the advertisement, in accordance with various embodiments of the present invention, marketing budgets may instead be used to pay for a consumer's time used for a multitude of marketing engagements, not online space of the content provider. Positive consumer experience, direct value to consumers as well as brands (and potentially other beneficiary organizations), and ultimately an improved advertisement audience are at the core of the present invention.

The present invention presents a new relationship between consumers and brands. The invention allows consumers to have full control of their browsing behavior, while auctioning their time, and choosing preferred time, place and form of communication for receiving information from marketers. Unlike, for example, loyalty programs that require consumers to shop from a specific site in order to gain benefits, consumers may interact, shop and browse when and where they prefer, through a browser plug in, mobile application, set top box application, Internet accessible application or the like that allows access to various brand information at any time, in a manner determined by the consumer, and in a substantially uninterrupted manner. Additionally, when employing the embodiment of the invention that allows for the support of one or more beneficiaries through the transfer of a portion of funds earned by the consumer to that beneficiary organization, consumers have full transparency into where any money they raise and provide to the beneficiary organization comes from, where it goes, and how it is spent by the beneficiary organization.

For brands and other marketing organizations, the various embodiments of the present invention similarly provide a number of significant benefits. Brands maintain flexibility and the ability to mix and match media formats and valuable online contexts in accordance with their marketing strategy. Furthermore, any advertising performed in accordance with the present invention may be more cost effective in that the marketing organization may target and bid for the time of a targeted consumer base at a fraction of the potential of blanketing a website with marketing information and hoping one or more relevant consumers are convinced to interact with the information, and based on well-defined marketing objectives that are quantifiable by metrics that measure the effectiveness of a given marketing campaign for the brand. As is well known, it is often the case that a small number of consumers, customers, clients or the like may provide an outsized portion of the returns for a business. In accordance with various embodiments of the invention, it is contemplated that brands will be able to focus more intently on that portion of their customer base that is likely to provide outsized benefits. Thus, by focusing on desirable consumers who are willing to auction their time, and by allowing those consumers to define methods by which they prefer to receive such brands are more likely to be advertising to a receptive consumer with an appropriate amount of time available to truly interact with the various brand presentations. It is contemplated in accordance with various embodiments of the invention that consumers who choose to interact with particular brands, and define methods in which the prefer to interact, and times during when they may be most receptive to this interaction are motivated to receive various content, and are therefore most likely to purchase or otherwise accept the various brand information presented to them via their chosen delivery method, at a their chosen available time.

The data presentation and advertising models suggested in accordance with the present invention therefore allow brands to present information to willing, desirable consumers in a manner designated as acceptable to the consumer. Brands can therefore be sure that their advertising or other dollars are being put to the most cost efficient and beneficial use. This is in opposition to many current advertising models in which an Internet site with greater traffic is considered to have a better advertising reach, and therefore charges higher premium for advertising. Even in a closed bid auction systems such as that provided by Google®, in markets where Google® has predominant search share, more brands desire to interact and rely on Google campaigns, and thus drive demand for certain keywords in that market. This increased demand in turn drives the bid prices higher, thus resulting in a greater required advertising spend in order to gain control over a keyword that is hoped will aid in efficiently presenting marketing material and other information to consumers. There is, however, no guarantee that these sites with higher traffic in fact provided better advertising reach for a particular marketing objective. Indeed, it is unlikely to receive a focused group of potential customers on the largest sites as the variation in customer profile is likely very great. Furthermore, by presenting such advertising to a consumer at any various time, the consumer may not be available at that particular time to view the advertising. Even when presented in accordance with entry of various search terms by a user, the user may not be available to truly interact with any presented information as the user may be focused on retrieving particular desired information, may be in a rush, or may be otherwise unavailable to pay complete attention and properly interact with presented information.

In some embodiments of the present invention, beneficiaries may also benefit from the describe time auction and overall interaction paradigm. A missing part in much of today's advertising industry is the lack of benefit to the world at large from money that flows between various industry participants. There are many great social initiatives and noble causes supported by many brands and businesses. Few of these initiatives, however, empower consumers to direct funding to a desired charitable organization or other designated beneficiary or cause, this funding having been raised as a portion of the money paid to the consumer in exchange for his or her time.

Therefore, in accordance with various embodiments of the invention, both consumers and brand organizations may reduce costs while maintaining very positive social status and image.

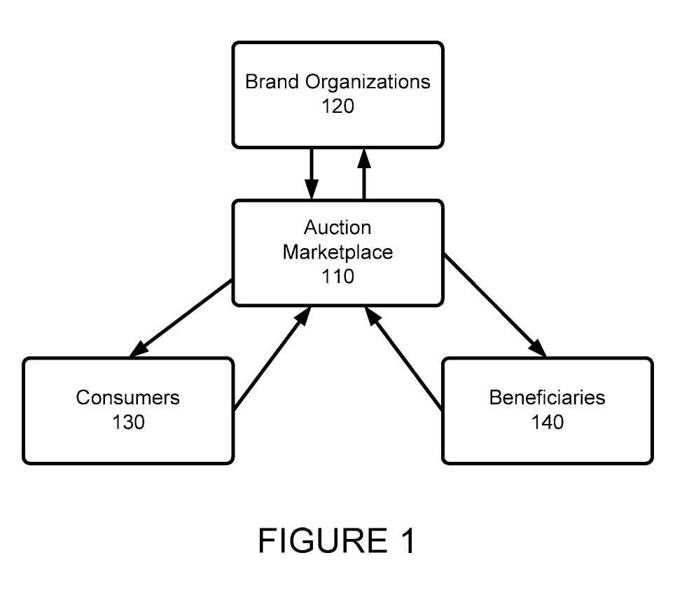

Referring first to FIG. 1, a relationship between the parties involved in the implementation of one or more embodiments of the invention will be described. As is shown in FIG. 1, in accordance with a preferred embodiment of the invention, an auction marketplace 110 is at the center of all transactions between the other participants in the system. In particular, a consumer 130 may indicate via auction marketplace 110 that this consumer is willing to auction a portion of their time. Such time may be designated by amount, particular times of the day, or in any other appropriate manner. Additional demographic and other preference information may also be included along with the time auction listing, although it may be desirable to provide a flexible platform to allow the user to remove any personally identifiable private information as desired or necessary in accordance with any laws, applicable regulations or industry standards. Thus, auction marketplace may include a mechanism for confirming that the demographic and other preference information provided by the consumer is accurate.

After collection of all appropriate information, the consumer's time auction listing may be compiled and listed at an auction site accessible by one or more brands or marketing organizations 120. Each marketing organization can review the posted time auction listings for one or more consumers 130 in a global manner, allowing the marketing organization to view all available time auctions, and to filter these listings based upon any one or more desired characteristics. It is contemplated that a user interface provided to brand organizations 120 may allow for searching and sorting of the time auction listings by time available, time of day available, or any other demographic or preference information category collected by auction marketplace 110 and provided by consumers 130. After review of all such available time auction listings, brand organizations may select one or more time auction listings, either individually or as a group in whole, and engage the associated consumers.

After one or more engaged consumers participate in the agreed upon marketing requirements for the agreed upon time by performing any designated actions by the marketing organization 120, the marketing organization transfers an agreed upon payment for consumer 130 to auction marketplace 110. Auction marketplace then designates a portion of this payment to an account for consumer 130, and a portion of this payment to one or more designated beneficiaries 140. The amount provided to consumer 130 and beneficiaries 140 may be determined in accordance with any number of factors, including but not limited to overall money raised for beneficiaries, amount of time auctioned, various membership levels that may be reached by an individual or group of consumers, or in accordance with any other desired metric.

After receipt of any such payments by beneficiaries 140, it is contemplated in accordance with the invention that such beneficiaries report to auction marketplace 110 the status of any projects, and the use of such payments, which may in turn be reported to consumers 130 who provided portions of payments to that particular beneficiary 140. Therefore, as is shown, time auction marketplace 110 allows for brand organizations, consumers and beneficiaries to interact in a unique manner that provides benefits to all three groups.

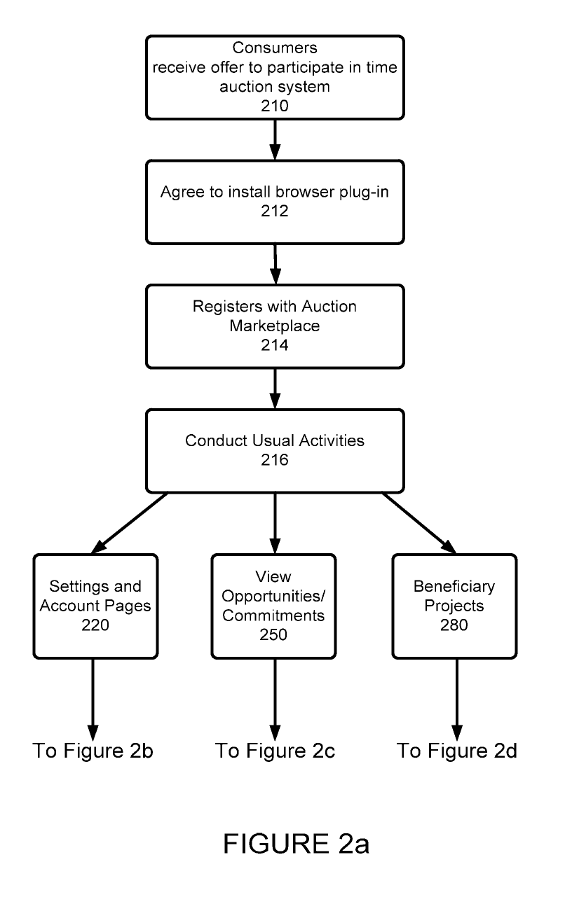

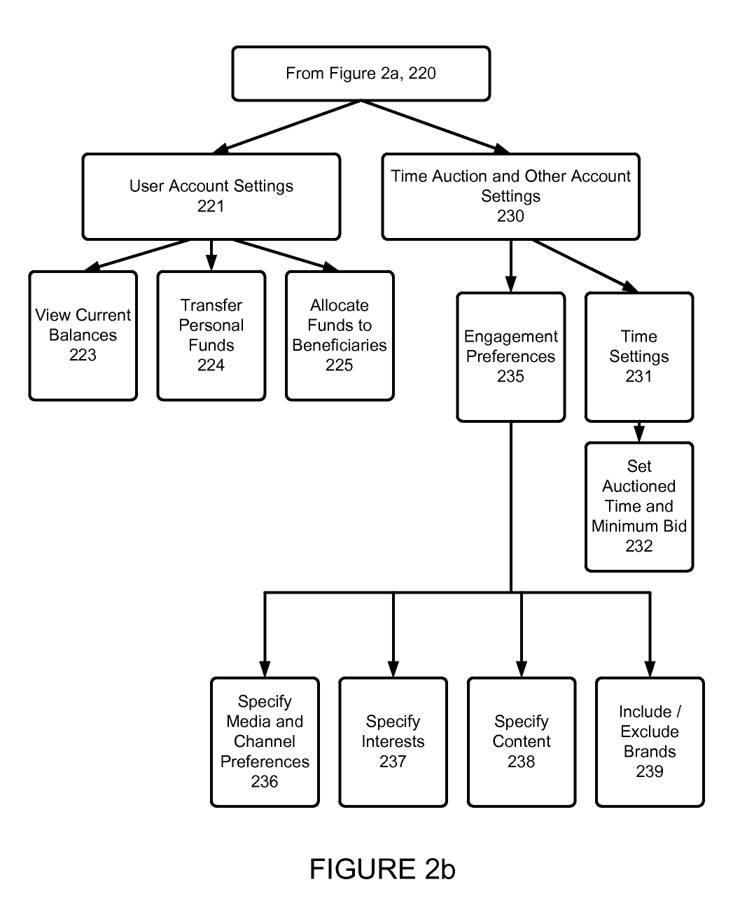

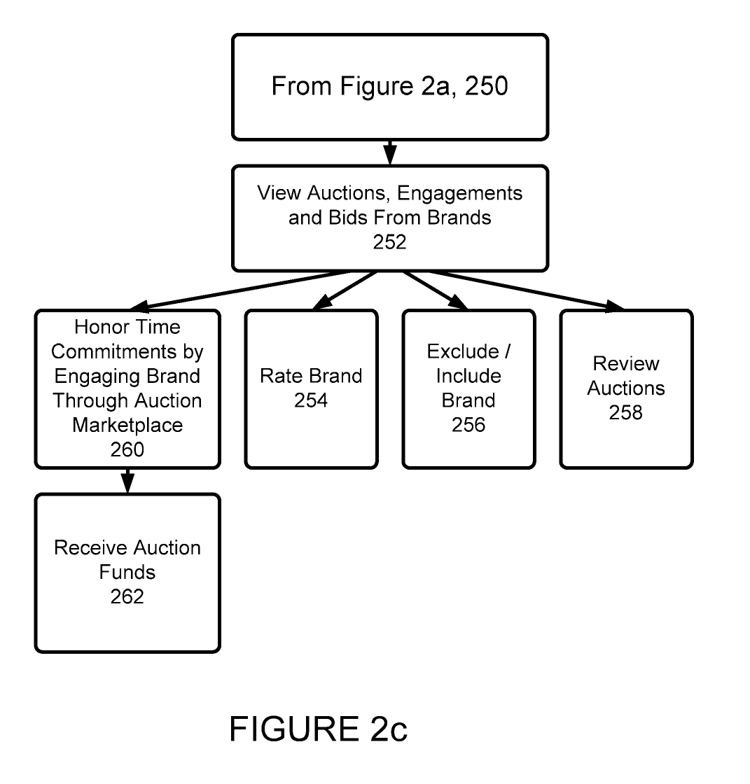

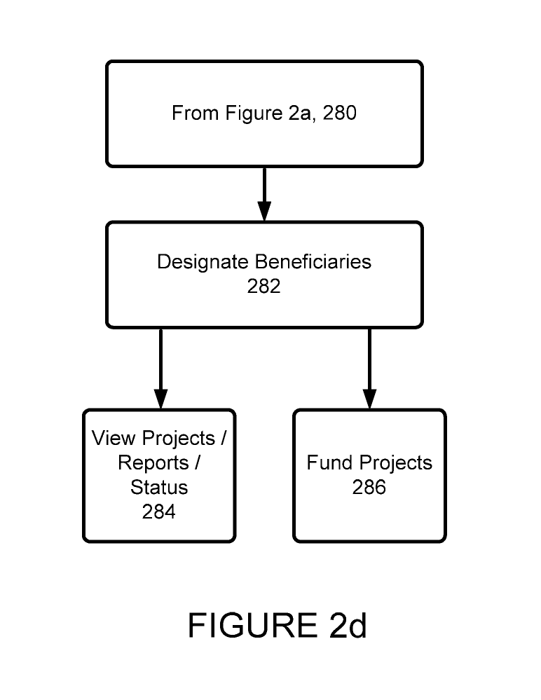

A more detailed view of each of the parties described in FIG. 1 will now be described. Referring next to FIGS. 2a-2d, consumer participants 130 preferably receive an offer to participate in a time auction system at step 210, and at step 212 the consumer accepts the offer and agrees to install a browser plug-in, or other device interface, such as mobile application set top box application or the like. The plug-in or application serves as a thin non-intrusive getaway interface to the time auction system 110, and after installation, allows consumer 130 to register with the auction marketplace system at step 214. After registration, the user is then able to interact with the system a number of ways, conducting various predetermined activities noted at step 216. These activities include settings and accounts pages 220, viewing opportunities and/or commitments between the user and any brand or marketing entity, and review a relationship between any beneficiary projects at step 280.

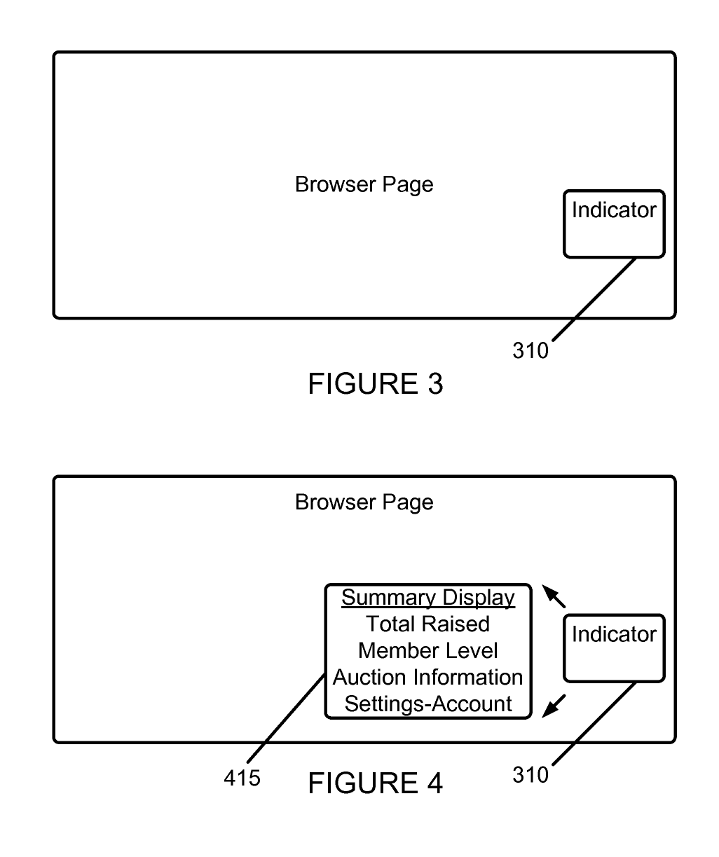

The user can preferably interact with the system, accessing these various activities by clicking on a small floating icon in one of the corners of a browser widow or browser menu bar (configurable by the user) as is shown at 310 in FIG. 3, resulting in a summary display of information as shown at 415 of FIG. 4. This method and display for engaging the system may preferably be modified to work with any desired information access device, including but not limited to appropriate interfaces for mobile devices, portals, set top box application or the like. This summary display of information may show account data, such as total amount of raised funds, and any number of links to other account pages, such as, by example, one to settings page 220, commitment/opportunities page 250, or projects page 280. This account information preferably updates in real time when the user interacts with digital communication in accordance with their choice settings and time auctioned. Of course, access to the account information and functionality shown here may also be provided in accordance with a more conventional web portal, mobile device, set top box application or the like, or other access means.

From such a summary display, or through other account access method, the consumer may first access a settings page at step 220 that allows the user to configure all channel and digital media type controls from a single, intuitive location upon selecting the settings link. A more detailed view of steps that may be used by the user in the settings menu may be shown in FIG. 2b, where the user may be offered a choice between user account settings at step 221, and time auction and other account settings at step 230. Upon selection of user account settings at step 221, a user is able to view current account settings at step 223 and either transfer some of these funds to a personal account at step 224, or transfer some of these funds to a beneficiary at step 225, the process for determining which funds may be transferred, and for designating beneficiaries being described below. Additional user account settings modifying the user experience and the like may also be provided.

If the user instead opts to interact with the time auction and account settings at step 230, the user may select between modifying time settings at step 231 or engagement settings at step 235. Selecting modifying time settings may allow the user to set limits of their time that may be auctioned off, thus allowing the user to designate when they are available for interacting with material provided by a brand, and also setting a minimum bid for their time at step 232. If the user instead decides to modify their engagement preferences, the user is provided with a method for specifying various preferences that may allow a brand or other marketing organization to determine whether the consumer would be an appropriate individual to interact with one or more campaigns. These settings include specifying desired media and channel preferences at step 236, specifying interests at step 237, specifying interesting content at step 238, and indicating a desire to either include or exclude particular brands at step 239.

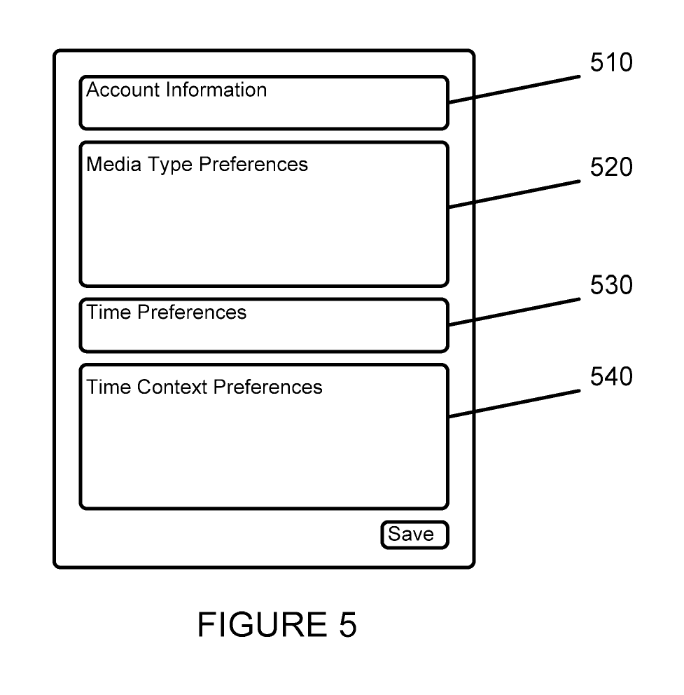

An example of such a settings page is shown in FIG. 5, and includes sections for account information 510, media type preferences 520, time preferences 530 and time context preferences 540, each of these components of a consumer profile essentially acting as a filter to wade through any number of potential opportunities that might be requesting a time auction. Other fields may be provided for one or more users, and may further include the fields noted with respect to specification ability in FIG. 2b. Thus, while typically the consumer might simply indicate a desire to auction time, in one embodiment of the invention, a marketing organization might indicate a desire to “bid” on time for a particular advertising campaign, or may wish to interact with consumers fitting a particular demographic. In this case, the inventive time auction marketplace may allow a “request for time” section in which such requests are submitted. Thus, consumers and brands may interact in any number of manners, utilizing the inventive time auction. Thereafter, a consumer's profile settings may allow for the user to be informed at all times if such a request may result in an engagement for them. The consumer may also set a minimum bid requested, and such information will be submitted to the auction along with the auctioned time, and made available for matching with bids placed by brands.

Referring back to FIG. 2a, a user may view, modify and/or otherwise interact with various possible earning opportunities or present commitments, the user may select step 250, where processing then passes to FIG. 2c. Upon selection of viewing commitments and opportunities, processing passes to step 252, where one or more brands may bid and thus preferably bind the consumer to terms for viewing and interacting with brand content. Thus, once the consumer places their time and restrictions up for auction, an acceptance by a brand preferably binds both parties to the transaction. If the consumer time is auctioned, and there are multiple brand bidders, the most desirable auction offer, preferably determined by the highest price, will win and bind the consumer. In an additional embodiment of the invention, after acceptance by the brand, the consumer may still have the right to accept or reject the bid offer, thus allowing the consumer to account for any changed circumstances, undesirable brands or the like. It is also contemplated in accordance with one or more embodiments of the invention that all bids are fluid, and may be changed at any time up until acceptance by the consumer, thus allowing consumers to maximize their earning opportunities by reviewing their time auctions to be sure they do not miss out on earning opportunities presented to them. After accepting or rejecting a particular bid, the user may proceed to either rate a particular brand at step 254, exclude or include a brand at step 256, review any currently pending auctions or recently completed auctions at step 258, or further engage in the time commitments accepted by the user at step 260. Thus, in accordance with one or more settings provided by the user and agreed upon by the brand or marketing agency, the user received the designated content and interacts with that content. After such interaction has been completed, the user receives any agreed upon funds at step 262.

When there is an earning opportunity from the time auction marketplace that matches user's time commitments, channel preferences and/or other demographic information, the consumer may be notified of such at step 258 through the summary display 310, or other convenient means. If the marketing organization has indicated a desired price it is willing to pay for such time, an amount that may be earned if the consumer were to auction their time and the marketing organization accept it. To meet such marketing organization demands, the consumer can choose to make a quick time auction from the summary display, thus presenting terms that meet the marketing organization request, or click on a “more” link to show additional auction settings displayed in an expanded layer, thus allowing the consumer to present a more varied time auction offer.

In order to set up a time auction, the consumer preferably logs on to the auction marketplace account, and in an unsolicited manner, indicates an available time, and any other constraints/conditions on the commitment of time, and also includes any other supporting or requested parameters, as describe above. Once their time auction has been bid upon by and matched to a brand or marketing organization, either based upon a previously entered screening criterium, or based upon a new screening criterium entered by a brand after entry of the time auction by the consumer, the user receives a communications in accordance with auction-matched engagement, and after meeting the commitments indicated as required by the user in accordance with the stated auction terms (i.e. after the consumer interacts with any designated content) funds may be credited to user's account, and to a beneficiary funds escrow account. The user can claim their portion of the funds through one of the payment/redemption methods provided (including funding personal project, or cash disbursements through various payment systems) and the user can allocate funds to designated beneficiaries from their portion of the funds in the beneficiary escrow pool, as will be described below.

Referring once again back to FIG. 2a, the user may select a beneficiary project page at step 280, and thus designate beneficiaries to receive a portion of the proceeds earned by the consumer. Upon designation at step 280, processing passes to FIG. 2d where the user is able to designate one or more beneficiaries to receive funds at step 282, view various projects and status reports for projects to which they have contributed at step 284, and fund various selected projects at step 286.

Referring once again to FIG. 1, the third group of participants in the system are beneficiaries 140. As noted above, these beneficiaries receive funds directed to them from consumers who have earned these funds from brand organizations. Partnership beneficiaries, such as charitable organizations register with the auction marketplace, and provide organization and project information as part of auction marketplace beneficiary profile. Once the profile is approved, funds from user contributions can be directed to the beneficiary. In a particular embodiment of the invention, beneficiaries may have only one ongoing support requirement: to provide a monthly project report, thus providing valuable feedback to marketplace participants on funds use. Reports may be automatically published at the auction marketplace, and consumers who have directed funds to these beneficiaries may be notified when new reports are available.

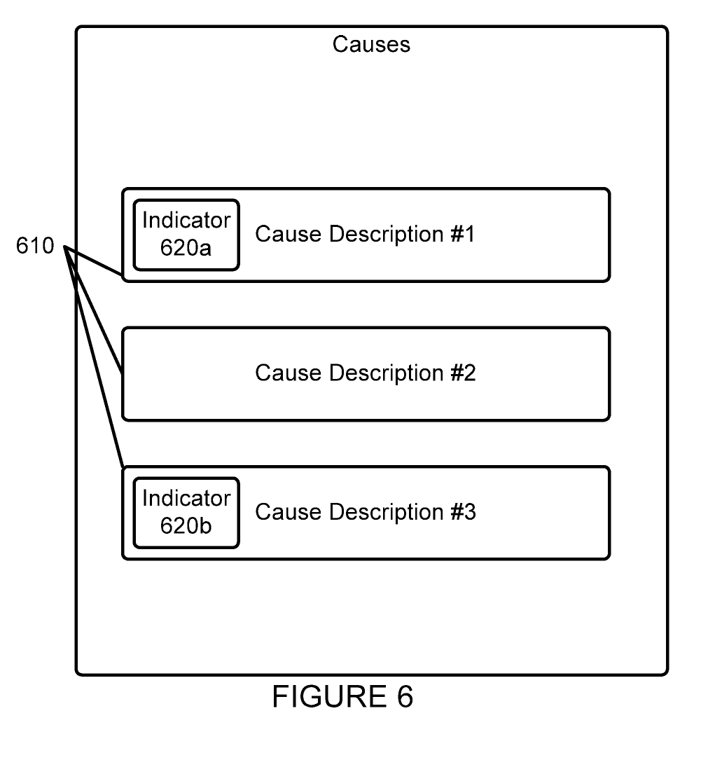

Referring next to FIG. 6, a Projects page accessible to a consumer registered with the auction marketplace is shown, and includes one or more entities, or projects 610, which the consumer may designate as a beneficiary 140. If such a Projects page is part of a third party offering, one or more indicators 620a, 620b may be provided indicating one or more projects that may be designated in accordance with the inventive time auction marketplace. In addition to selecting an existing project as a beneficiary, a consumer 130 may create a new project to act as a beneficiary. In a preferred embodiment, auction marketplace may limit the types of projects available to be placed onto the projects page. For example, such projects may be limited to qualified charities, local humanitarian groups, or any other limitations as desired. Projects may also include any project within the rules designated by the auction marketplace for which the consumer wishes to raise funds. It is preferred that the project agree to report back to the auction marketplace and any consumers who have contributed funds to the project.

Once a project is formed, the process of allocating funds to any of the projects may be as easy as a one click process, as noted with respect to FIGS. 2b and 2d. The user indicates the amount from total available allocatable funds associated with their account and selects the project. This same projects page allows the user to see monthly status and progress reports from the projects they funded, and provides integration points with other social networking and funding sites.

In an alternative embodiment of the invention, it may be possible to use a third party beneficiary page, such as Facebook® Causes or the like to link to the Projects page of the auction marketplace. In such a situation, when a consumer views such a third party causes pages, all causes which may be eligible for selection as a beneficiary in accordance with the auction marketplace may be indicated with a visual or other link back to the Projects page of the auction marketplace. Thus, when viewing such a third party causes page, upon notice that a desired listed cause is available in accordance with the auction marketplace system, the consumer is easily able to select the visual link and be transported to the Project pages, where he or she can designate funds to be directed to that project in the manner as noted above. Furthermore, such third party providers may also act as receivers of funds, or otherwise interact with the inventive time auction marketplace, thus potentially expanding the reach of the inventive system and method.

In accordance with a preferred embodiment of the invention, the percentage of funds earned by auctioning time may be directed to any number of categories of projects that may be varied in accordance with any number of criteria. In accordance with an embodiment of the present invention, projects are divided into two categories, charitable projects, and personal projects. Thus, consumer status at the auction marketplace may be used to determine to which groups of projects and in which proportions the received payments may be directed.

In accordance with an embodiment of the invention, there may be provided three different levels of consumer status to allow for direction of accumulated funds. As the user automatically progresses from one membership level to another, he/she is able to claim larger portion of accumulated funds for self-started or personal projects, and have the ability to draw funding through integrated social networks by referring other users to the system and therefore earning a reward or the like, and other Internet based services, such as affiliate programs. At a first, introductory level, for example, users might be able to make contributions to charitable projects using up to 95% of their time auction proceeds, and direct up to 5% of these funds to personal projects. To move from level to level, users may accumulate points in a form of dollars raised for charity, and through accumulation of funds raised by the user and their network, automatically advance to a next second level, for example, once the total funds raised reaches $500. Users at this second level of membership may start using, for example, up to 30% of auction proceeds to fund any personal projects. Third level of membership, at for example $1000 in total funds raised, may make up to 90% of user auction proceeds available for funding personal projects. Users continue directing up to 10% of funds raised to chosen beneficiaries. Of course, the indicated percentages, levels, etc. are presented herein by way of example only, and any desirable level scheme may be employed.

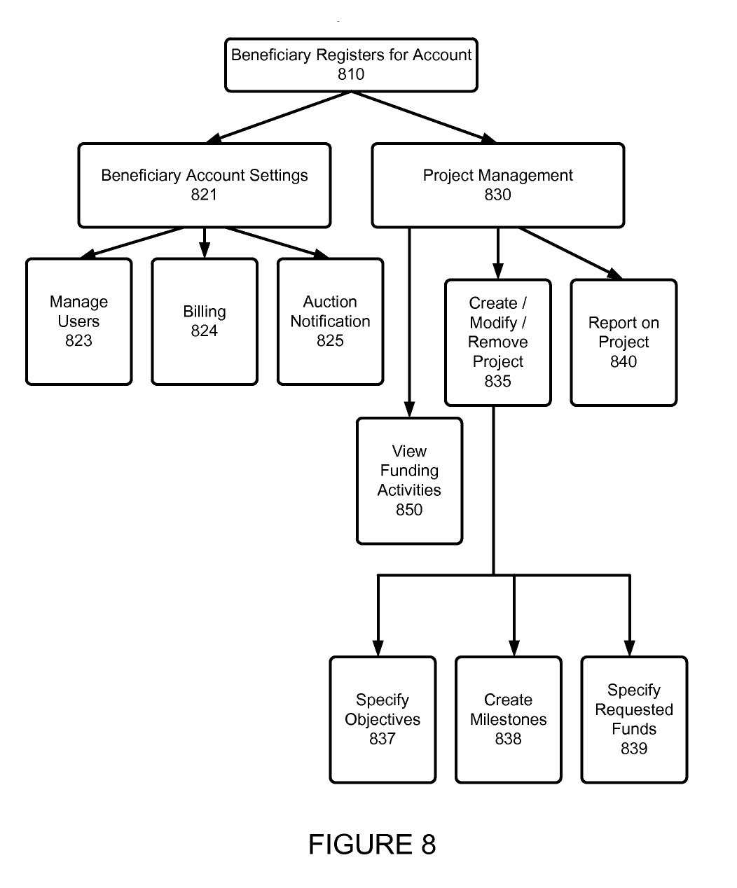

Beneficiaries may interact with the time auction system as shown in FIG. 8. As is shown, each beneficiary may register for an account at step 810, and then may have access to beneficiary account settings at step 821 and project management at step 830. Through the beneficiary account settings, the beneficiary may designate and manage user associated with the beneficiary organization at step 823, may provide for billing of various entities at step 824, and may set one or more auction notifications at step 825. Such auction notifications may allow for setting of one or more filters that will provide notification to one or more of the beneficiary users of entry of an auction that indicates the beneficiary to receive funds if the auctioned time is bid upon, and may further indicate when an accepted auction will pay funds to the beneficiary organization in the future.

Through project management step 830, a beneficiary organization may create, remove or modify a project for which funding is requested at step 835, report on the progress of such a project at step 840, and view various funding activities associates with such a project at step 850. When creating or modifying a project, the beneficiary may specify project objectives at step 837, create milestones for the project at step 838 and specify requested funds at step 839. Beneficiaries may register a project, as noted above, after setting up a standard beneficiaries account with the auction marketplace. They may also update status and progress once the project is started. Funds donated to the project are preferably released gradually, as the project moves along its milestones, which are specified and reviewed at registration time. The rest of activities of the auction are non-binding to the beneficiaries, and all services that marketers and consumers can use are also accessible to the beneficiaries.

Referring once again to FIG. 1, brand and brand organizations 120 may access auction marketplace in order to review time auctions and purchase consumer's time, initiate a request for time auction, thus letting consumers know that they are looking for particular groups of people for a particular marketing opportunity, and manage their accounts with the auction marketplace. As noted above, marketing in this manner allows brand organizations to create a unique one on one relationship with each target consumer individually. The inventive auction marketplace gives these brand organizations the ability to bid for consumer time in an auction setting. In accordance with an embodiment of the invention brand organizations are able to deliver their advertising via a flexible delivery platform that supports digital engagement campaigns that may be provided to consumers in any number of ways via any number of media. They are also able to advertise and ensure interaction with desirable consumers for any category of advertising, including, for example, search, contextual advertising, social media, loyalty programs, video display, digital event marketing, product and market surveys, consumer feedback, corporate communications, and just about any type of one on one digital media campaign or interactive engagement with consumers. The inventive auction marketplace is built upon a flexible cross-channel marketing delivery network designed to bring flexibility, full price control, and transparency to brand organizations.

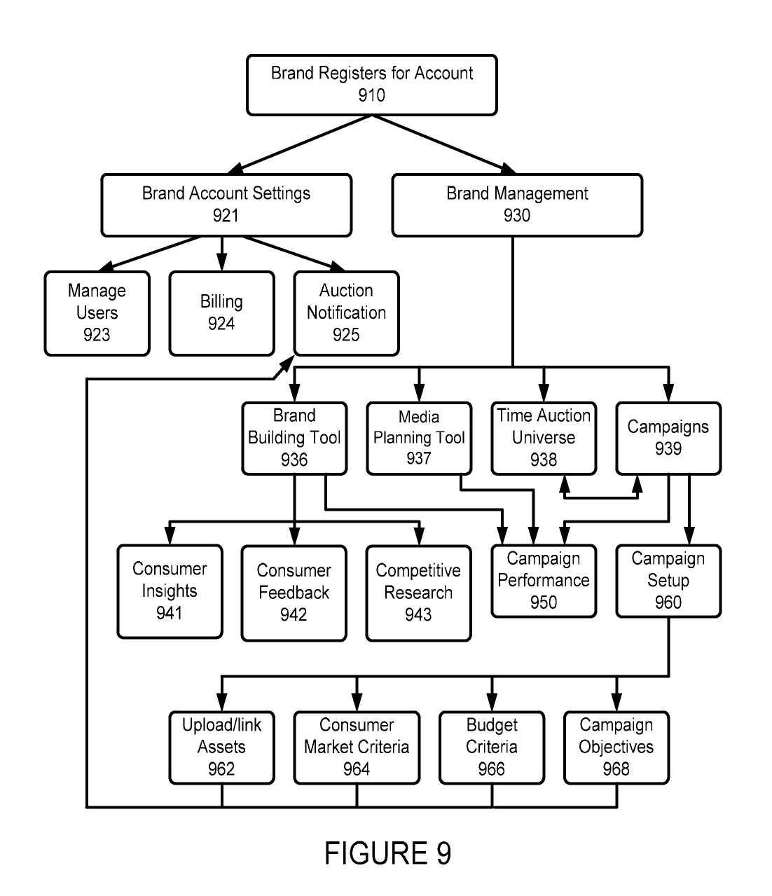

FIG. 9 depicts a manner in which a brand or marketing organization may interact with the inventive time auction system of the invention. As is show in FIG. 9, first, such a brand or marketing organization may first register for an account at step 910, this account allowing them access to their account settings at step 921 and to various brand management features at step 930. Through the brand account settings at step 921, the brand or marketing organization may manage various users associated with the brand organization at step 923, perform various billing and payment functions in step 924, and set various criteria indicative of auction criteria for which they will be notified. Thus, the brand organization may determine particular demographic requirements, time availability, media delivery methods, or any other criteria that may determine whether a potential consumer auctioning time may be desirable to the brand organization. If one or more time auctions by one or more consumers meets the designated criteria, the brand organization will be notified of such an auction, and can make a bid in that time auction, either personally, or automatically. Details of such criteria setting will be described below.

Upon selecting the brand management control at step 930, the user associated with the brand organization is presented with a number of modules. These modules include a brand building tool 936, a media planning tool 937, a time auction universe application 938, and a campaign planning module 939. The brand building tool 936 enables brand marketers to gain deep interaction insights, and allow brands to build their products and services using direct consumer feedback. that is structured to provide maximum decision effectiveness. Brand managers can also use this tool to collaborate with media planners and provide direct input to the media planning activities in an integrated way. The brand building tool provides access to various consumer insights at step 941, consumer feedback at step 942, and competitive research at step 943.

Media planning tool 937 gives media planners the ability to create and deploy campaigns across digital media channels. The planning starts with research and selection of matching consumer audience from the time auction universe. Information can be searched and viewed based on different criteria, such as total available pool of consumers, interests, demographics, summary statistics from current campaign objectives, marketing costs, web context, media types and channels. Once a pool is identified, and campaign created, a media planner or buyer can place bids in the time auction to reserve consumer initiated channel. The delivery of supported digital engagements may start immediately, and according to consumer preferences for time, place, media type and other criteria.

The time auction universe at step 938 presents a view of various auction statistics and data, that can be searched and displayed based on different criteria. This module also allows brand users to research and find matching audiences in different markets for their campaigns. Thus, brands may be provided with a toolbox for determining segments of various populations that might be desirable to one or more particular marketing campaigns, and also allow the brands to determine other commitments of one or more consumers or groups of users to determine further desirability of those consumers. Results can be saved for later deployment within a campaign. Campaign module 939 allows marketing campaigns to be setup based upon any number of criteria, including information received from the time auction universe 938, from measurements of campaign performance at step 950, and including various feedback and input from brand building tool 936 and media planning tool 937. This input is all provided and included in designing one or more marketing campaigns at campaign setup 960. In accordance with this campaign setup, a brand manager may define various desirable campaign objectives at step 968, budget criteria at step 966, including amount, spend ratio and exclusivity possibilities, and consumer marketing criteria at step 964, including desired time, content delivery methods, interests of the potential consumer, media types, and various key phrases for contextual and search campaigns. Step 962 allows for uploading and link of a finally designated marketing campaign, including one or more of the features noted above, to be provided to auction notification module 925, thus allowing the marketing campaign to define the types of consumers to be targeted and bid for.

Therefore, in accordance with an embodiment of the invention, the inventive auction marketplace provides market driven media pricing across all supported Internet-enabled channels and devices. Pricing may be based on auctioned consumer time (cost per time unit), where brand organizations preferably pay for 10 second or other increments of consumer time in a particular web browsing context at consumer initiation and discretion, and after agreeing upon such interaction in accordance with the purchase of such time by the marketing organization in an auction setting. Alternatively, rather than paying for short time intervals, auctions may be priced based upon price per complete interaction, or on any other agreed upon transaction between consumer and marketing organization.

Through the harvested power of social trends online, a unique value proposition to consumers and brands, and innovative auction marketplace technology a freewill marketplace is provided where consumers and brands can interact and gain value from partnership in pursue of consumer social interests, giving consumers a greater role in marketing value chain, and giving brands access to target consumers that are open to interact with the brand. This means higher conversion rates and higher degree of communication control for brands.

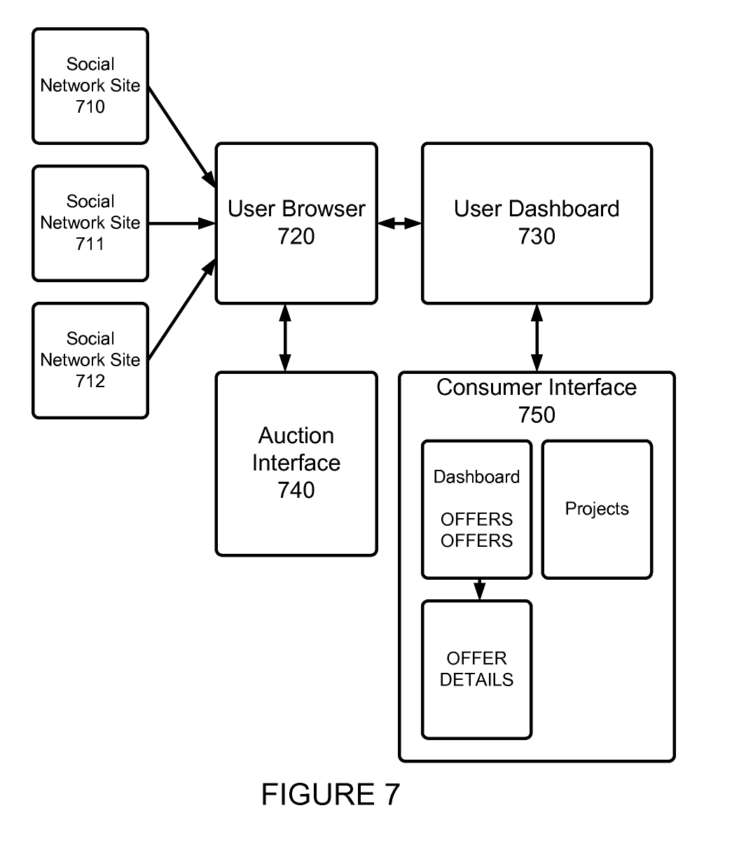

Referring next to FIG. 7, a more detailed view of the interaction of marketing consumers 130 with other aspects of the system will be described. Such a consumer may utilize a web browser 720 while viewing one or more social networking sites 710, 711, 712, or other appropriate website. While such browsing, if any particular information regarding an auction such as an accepted bid, a request for bid, or other information that may be useful to the consumer becomes available, a user dashboard 730 is provided to the user, and described above, preferably as a summary display to the user. Access is further provided to a consumer interface 750, providing more detailed information to the consumer related to any offers that are presented to them, any auction results, and information about any beneficiary projected to which the consumer may have, or may be interested in transferring earned proceeds. An auction interface 740 may also be provided to allow the user to more completely interact with the system as a whole. Thus, as is shown in FIG. 7, the user browser 720 (or other access device or method) gives the user access to a very powerful tool for managing their interactions with brands, managing their time auctions, and further managing their charitable projects.

The interface for brand organizations supports a number of activities: creation of campaigns, bidding for consumer time, reporting, management of media assets and delivery of advertising or media assets to engaged consumers. Once logged into the auction marketplace, At first engagement an account is opened for each marketing organization. After logon, each marketing organization may be shown a total pool of consumer time available by auction, indexed by internet context and preferences set by the consumers. Searching these auctions, or displaying time auctions in accordance with one or more preset or adjustable filters may also be provided to the marketing organization. Therefore, brand organizations can make bids on time in a particular context, and target consumers by the various preferences they set. They can also monitor performance, and create new campaign. For campaign creation brand organizations may employ browser plug ins, links on their account home pages, of or the like.

The interface for marketers may be based upon that for consumers, except that for such users additional reporting capabilities and other functionality may be unlocked. These additional features for marketers may enable campaign creation in a context sensitive manner. The brand user may be able to add “context” to campaigns while browsing particular sites, where they can see user/time statistics real time, and decide if this context is relevant to their campaign. Thus, the brands may be able to determine whether particular browsers are desired customers, and selectively target them. Also, the features may allow the brand users to create campaign layouts, where appropriate, such as to specify where and how the ads will appear for users in a particular context. And finally, the brand users may be able to place bids for consumer pools within the context. Additional auction functionality may also be provided to marketers, allowing for context sensitive interaction therewith. In accordance with embodiments of the present invention, the consumer may be given control of the demographic or other identifying information they wish to release to brands or the like. They may be able to determine what information the brands may use when making determinations of whether the particular browser is a desirable customer, and therefore gain additional control over the brand/consumer interaction. The consumer may also preclude a relationship with a particular brand, group of brands, product, service, or content delivery method, as they wish.

Brand organizations may associate themselves with specific beneficiaries for PR reasons, and beneficiaries can take on a marketing organization role if they desire to bid for auctioned time. For any such beneficiaries, the time auction may forecast benefits based on membership level statistics, and gives a part of their marketing spend back as a discount. Brand Corporations can also become beneficiaries, but their projects must comply with the auction marketplace requirements related. A beneficiary who also buys time may be given a discount by allowing funds provided to them as a beneficiary may be funneled back into the system to pay for further marketing spend. Thus, such a beneficiary may use accumulated funds for any project, including additional marketing.

Therefore, in accordance with the various embodiments of the invention, a time auction marketplace is provided that encourages interaction between brands, consumers and beneficiaries in a manner that allows consumers to have control over the interaction with brands, allows brands to reach the most desirable potential consumers, and for beneficiary organizations to benefit from the flow of money from the brands to the consumers, thus providing a win-win-win situation for the participants.

Still other objects and advantages of the invention will in part be obvious and will in part be apparent from the specification and drawings.

The invention accordingly comprises the several steps and the relation of one or more of such steps with respect to each of the others, and the apparatus embodying features of construction, combinations of elements and arrangement of parts that are adapted to affect such steps, all as exemplified in the following detailed disclosure, and the scope of the invention will be indicated in the claims.

What is claimed:

1. A method for auctioning a consumer's time, comprising the steps of:
receiving from a consumer, a desired set of characteristics associated with content to be received from a brand marketing organization, the desired set of characteristics comprising at least an indication of one or more periods of time during which the consumer is available to receive content from a brand marketing organization, a minimum fee for receiving the content from the brand marketing organization, and a method by which the consumer wishes to receive the content form the brand marketing organization;
presenting the desired set of characteristics indicated by the consumer to one or more brand marketing organizations in the form of an auction,
receiving from one or more of the brand marketing organizations a bid price for the right to present content to the consumer in accordance with the desired set of characteristics; and
receiving from the consumer an agreement to receive the presented content from the one or more brand marketing organizations at the bid price.

2. The method of claim 1, further comprising the steps of:
receiving the content from the one or more brand marketing organizations; and
presenting the content to the consumer in accordance with the desired set of characteristics.

3. The method of claim 1, further comprising the steps of:
receiving from the consumer a designation of a beneficiary organization; and
transferring a portion of the fee to the beneficiary organization upon completion of review of the presented content by the consumer.

4. The method of claim 1, wherein an amount of the bid price to be transferred to the beneficiary organization is determined at least in part in accordance with a status of the consumer.

5. The method of claim 1, wherein the one or more consumers receive the agreed upon bid price upon receiving and interacting with the content provided by one or more of the one or more brand marketing organizations.

6. The method of claim 1, wherein one or more consumers having similar desired set of characteristics may be presented to the one or more brand marketing organizations as a group.

7. The method of claim 1, further comprising the step of presenting one or more pieces of information about the one or more consumers to the one or more brand marketing organizations; and
whereby the one or more brand marketing organization may consider the one or more pieces of information when determining whether to indicate a desire to present content to one or more of the one or more consumers.

8. The method of claim 7, further comprising the steps of:
receiving from one or more brand marketing organizations a campaign definition;
determining one or more consumers meeting the requirements of the campaign based upon a comparison of at least one of the one or more pieces of information to at least one component of the campaign; and
presenting at least one metric to the at least one brand marketing organization to confirm whether the one or more consumers receiving content meets the requirements of the campaign.

9. A method for auctioning an individual's time, comprising the steps of:
receiving from an individual, a desired set of characteristics, the desired set of characteristics comprising at least an indication of one or more periods of time during which the individual is available to receive content, a minimum charge for receiving the content, and a method by which the individual wishes to receive the content;
presenting the desired set of characteristics indicated by the individual in the form of an auction,
receiving from one or more bidder a bid to present content to the individual in accordance with the desired set of characteristics; and
receiving from the individual an agreement to receive the presented content at the bid price.

10. The method of claim 5, further comprising the steps of:
receiving the content from the one or more bidder; and
presenting the content to the individual in accordance with the desired set of characteristics.

11. The method of claim 5, further comprising the steps of:
receiving from the individual a designation of a beneficiary organization; and
transferring a portion of the fee to the beneficiary organization upon completion of review of the presented content by the consumer.

12. The method of claim 7, wherein an amount of the bid price to be transferred to the beneficiary organization is determined at least in part in accordance with a status of the individual.

13. A computer program for auctioning a consumer's time stored on a computer readable storage medium, the computer program, when run, causing a general purpose computer to perform the steps of:
receiving from an individual, a desired set of characteristics, the desired set of characteristics comprising at least an indication of one or more periods of time during which the individual is available to receive content, a minimum charge for receiving the content, and a method by which the individual wishes to receive the content;
presenting the desired set of characteristics indicated by the individual in the form of an auction,
receiving from one or more bidder a bid to present content to the individual in accordance with the desired set of characteristics; and
receiving from the individual an agreement to receive the presented content at the bid price.

14. The computer program of claim 13, the computer program causing the general purpose computer to further perform the steps of:
receiving the content from the one or more bidder; and
presenting the content to the individual in accordance with the desired set of characteristics.

15. The computer program of claim 13, the computer program causing the general purpose computer to further perform the steps of:
receiving from the individual a designation of a beneficiary organization; and
transferring a portion of the fee to the beneficiary organization upon completion of review of the presented content by the consumer.

16. The computer program of claim 15, the computer program causing the general purpose computer to further perform the steps of:

17. The computer program of claim 13, wherein an amount of the bid price to be transferred to the beneficiary organization is determined at least in part in accordance with a status of the individual.

18. The computer program of claim 13, wherein the general purpose computer comprises a mobile computing device.

19. The computer program of claim 13, wherein the general purpose computer comprises a web interface for accessing a remotely hosted platform.

20. The computer program of claim 13, wherein the general purpose computer comprises a web interface providing a browser plug in enabled pop-up menu for interfacing with a remotely hosted platform.

21. The computer program of claim 13, wherein the general purpose computer comprises a set top box.
